(19) United States
(12) Patent Application Publication
(10) Pub. No.: US 2002/0122077 A1
(43) Pub. Date: Sep. 5, 2002

(54) MULTIPHASE, TASK-ORIENTED PROGRESS INDICATOR INCORPORATING GRAPHICAL ICONS

(76) Inventors: GARY CHARLES DONEY, SUNNYVALE, CA (US); MICHAEL MORRIS GOLDING, PALO ALTO, CA (US); SHU JUNG WANG, SAN JOSE, CA (US)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 09/223,080

(22) Filed: Dec. 29, 1998

(51) Int. Cl. G09G 5/00

(52) U.S. Cl. 345/853

(57) ABSTRACT

A method, apparatus, and article of manufacture for displaying the progress of a hierarchically structurable group of tasks is disclosed. The method comprises the steps of displaying a hierarchical representation of the group of tasks, delimiting a task in the group of tasks when the task has been processed, and displaying a processing result for the task in the hierarchical representation. In one embodiment, an icon is also displayed in the hierarchical representation to indicate whether the task completed normally or not. In another embodiment, the window displaying the progress of the hierarchically structured group of tasks further comprises an additional area to present additional information about the process, such as diagnostic information. The article of manufacture comprises a data storage device tangibly embodying instructions to perform the method steps described above. The apparatus comprises means for displaying a hierarchical representation of the group of tasks, means for delimiting a processed task in the hierarchical representation of the group of tasks, and means for displaying a processing result for the task in the hierarchical representation.

### BACKGROUND OF THE INVENTION

1. Field of the Invention

The present invention relates generally to software application graphical user interfaces, and in particular, to a method and apparatus for displaying an application task's progress by using a task-oriented progress indicator that incorporates graphical icons.

2. Description of the Related Art

Progress indicators are commonly used in software application graphical user interfaces (GUIs). These progress indicators can be broadly categorized into two forms. The first category includes a changing pointing device icon (e.g. a cursor that changes from an arrow to an hourglass or a watch when the task begins and returns to a cursor when the task completes). The second category includes graphical figures such as horizontal bars, that indicate progress by gradually filling in or coloring the bar as the task completes.

The first category of progress indicator tells the user only when the task has begun and when it is finished. With this type of indicator, the user does not receive any feedback on the expected length of the task, or in case of failure, what particular subtask or subtasks did not succeed.

The second category of progress indicator gives the user a better sense of the length of time that the task will take, and also gives the user a sense of movement through the task. However, because the graphical indicators are updated through sampling of the task's progress, they often do not give an accurate indication of how much of the task has completed, nor do they provide detailed information on the success or failure of each subtask. These indicators often do a poor job of estimating the time for an application to complete. It is not uncommon to see a graphical bar stopped at 98% of completion, with the last 2% taking more time than the first 98%. For example, the disk defragmenter that is supplied with many WINDOWS operating systems provides an estimate of the time it will take to defragment the disk. The estimate is based largely on how much data is currently stored in the disk. If there are many files that have been deleted from a folder, however, the defragmenter can spend a long time checking files that have been deleted, especially if the folder is currently empty. This expenditure of time is not taken into account in creating the progress bar, so it may appear that the defragmenter program has hung, because the bar does not move for an extended period of time, sometimes for as long as half an hour. The foregoing difficulties are especially onerous when the user attempts to create and run a model defined by an object model class hierarchy in an object-oriented programming environment. Before such a model can be executed, it must be built by compiling the defined classes. The compilation process can be lengthy, and the user is not provided with any information about the context of the compilation process. The user is not informed which classes have been compiled, which classes are about to be compiled next, the size of the classes compiled or to be compiled, or how the classes interrelate to one another in a hierarchical context. In addition, while the compilation process is proceeding, the user is given no detail to indicate whether a particular class compilation completed successfully, and if not, why the compilation failed. What is needed is a system for presenting a multiphase, task-oriented progress indicator to the user.

### SUMMARY OF THE INVENTION

To address the requirements described above, the present invention discloses a method, apparatus, article of manufacture, and a memory structure for displaying the progress of a hierarchically structurable group of tasks.

The method comprises the steps of displaying a hierarchical representation of the group of tasks, delimiting a task in the group of tasks when the task has been processed, and displaying a processing result for the task in the hierarchical representation. In one embodiment, an icon is also displayed in the hierarchical representation to indicate whether the task completed normally or not. In another embodiment, the window displaying the progress of the hierarchically structured group of tasks further comprises an additional area to present additional information about the process, such as diagnostic information. The article of manufacture comprises a data storage device tangibly embodying instructions to perform the method steps described above.

The apparatus comprises means for displaying a hierarchical representation of the group of tasks, means for delimiting a processed task in the hierarchical representation of the group of tasks, and means for displaying a processing result for the task in the hierarchical representation.

### BRIEF DESCRIPTION OF THE DRAWINGS

Referring now to the drawings in which like reference numbers represent corresponding parts throughout:

FIG. 1 is a block diagram showing an exemplary hardware environment for practicing the present invention;

FIG. 2 is a block diagram of a model class hierarchy as created in an ObjChart development environment;

FIG. 3 is a flow chart presenting an illustrative example of process steps used in reporting context-sensitive comments to a destination;

FIGS. 4A-4K are diagrams illustrating a graphical user interface for a multiphase, task-oriented progress indicator; and

FIG. 5A-5J are diagrams illustrating another embodiment of a graphical user interface for a multiphase task-oriented progress indicator.

### DETAILED DESCRIPTION OF PREFERRED EMBODIMENT

In the following description, reference is made to the accompanying drawings which form a part hereof, and which is shown, by way of illustration, several embodiments of the present invention. It is understood tat other embodiments may be utilized and structural changes may be made without departing from the scope of the present invention.

Hardware Environment

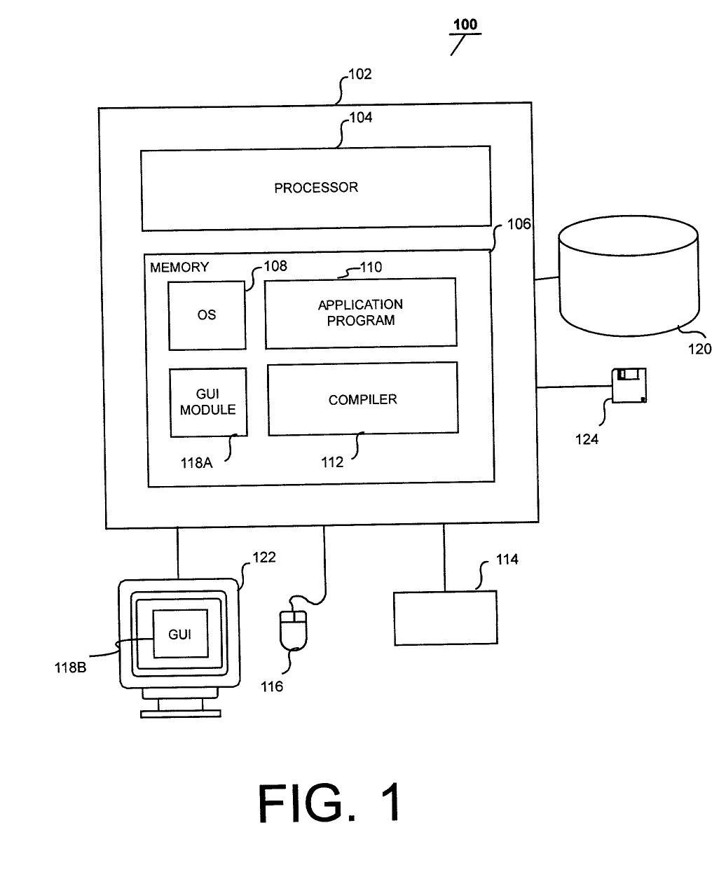

FIG. 1 illustrates an exemplary computer system 100 that could be used to implement the present invention. The computer 102 comprises a processor 104 and a memory, such as random access memory (RAM) 106. The computer 102 is operatively coupled to a display 122, which presents images such as windows to the user on a graphical user interface 118B. The computer 102 may be coupled to other devices, such as a keyboard 114, a mouse device 116, a printer, etc. Of course, those skilled in the art will recognize that any combination of the above components, or any number of different components, peripherals, and other devices, may be used with the computer 102.

Generally, the computer 102 operates under control of an operating system 108 stored in the memory 106, and interfaces with the user to accept inputs and commands and to present results through a graphical user interface (GUI) module 118A. Although the GUI module 118A is depicted as a separate module, the instructions performing the GUI functions can be resident or distributed in the operating system 108, the application program 110, or implemented with special purpose memory and processors. The computer 102 also implements a compiler 112 which allows an application program 110 written in a programming language such as COBOL, C++, FORTRAN, or other language to be translated into processor 104 readable code. After completion, the application 110 accesses and manipulates data stored in the memory 106 of the computer 102 using the relationships and logic that was generated using the compiler 112.

In one embodiment, instructions implementing the operating system 108, the computer program 110, and the compiler 112 are tangibly embodied in a computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of instructions which, when read and executed by the computer 102, causes the computer 102 to perform the steps necessary to implement and/or use the present invention. Computer program 110 and/or operating instructions may also be tangibly embodied in memory 106 and/or data communications devices, thereby making a computer program product or article of manufacture according to the invention. As such, the terms “article of manufacture” and “computer program product” as used herein are intended to encompass a computer program accessible from any computer readable device or media.

Those skilled in the art will recognize many modifications may be made to this configuration without departing from the scope of the present invention. For example, those skilled in the art will recognize that any combination of the above components, or any number of different components, peripherals, and other devices, may be used with the present invention.

Class Relationships

In ObjChart, users can create models having classes created in an ObjChart development environment. A class is an abstraction of an object or objects in the user's model. It is also a template for creating objects. The behavior and structure of classes are defined by their properties, including class general properties, attributes, operations (events and methods), states, and tag values. Classes can be related by inheritance, containment or association. Inheritance relationships define which classes inherit structure and behavior from other classes. Containment relationships can be used to define which classes contain other classes. Association relationships are used to define other relationships besides inheritance and containment.

Groups can have from zero to any number of members. A group has the following properties: name, visibility, type, member type, and description. There are two types of groups: containment groups and association groups. A containment group is an unordered set of objects of the same class or subclass of that class. Containment groups are used to (1) model an object that can be in only one group at a time, (2) send a message to a group and have it affect all of the group members, (3) create or delete similar objects dynamically or move similar objects between groups, and (4) model the deletion of group members when the object containing the group is deleted. An association group is a set of references to objects of the same class or subclass of that class. Association groups are used to (1) model an object that is associated with more than one group or that exists outside of the group, (2) send a message to a group and have it affect all of the members, (3) create or delete references to objects dynamically, and (3) move references to objects between groups. Further details regarding the definition of classes and their interrelationships is presented in co-pending and commonly assigned patent application Ser. No. 08/850,858, entitled “Object Outline View for Groups within an Object-Oriented System”, by Stephen Brodsky, et al., filed May 2, 1997, and co-pending and commonly assigned patent application Ser. No. 08/850,829, entitled “Method for Synchronization between Links and Groups within an Object-Oriented System” by Stephen Brodsky, et al., filed May 2, 1997, both of which applications are hereby incorporated by reference herein.

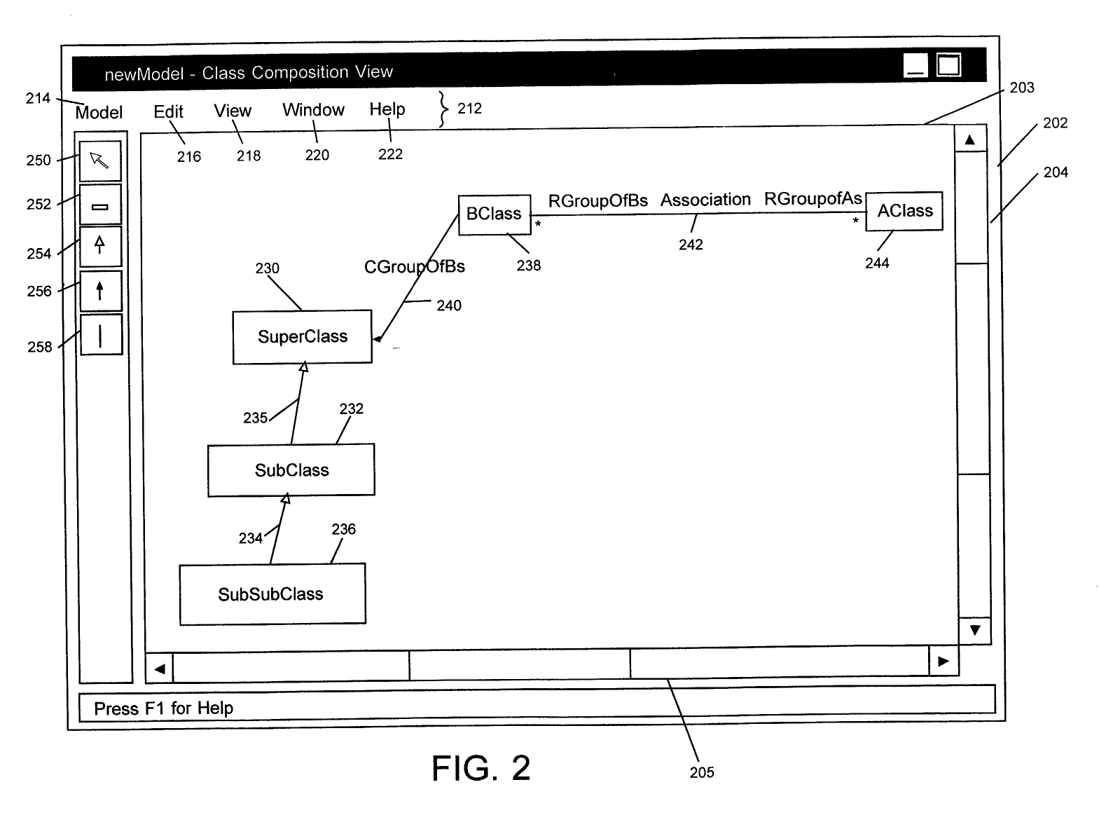

FIG. 2 is a block diagram of a window comprising a model class hierarchy as created in an ObjChart development environment. The window 202 includes view area 203 presenting the model class hierarchy. The apparent size of the model class hierarchy may exceed the view area 203. Hence, a vertical scroll bar 204 and a horizontal scroll bar 205 are provided to allow different portions of the model class hierarchy to be viewed. Task bar 212 provides a plurality of pull down menus, including a model pull down menu 214, an edit pull down menu 216, a view pull down menu 218, a window pull down menu 220, and a help pull down menu 222.

The window also comprises a reset pointer button 250 which is used to reset the pointer's (default) function, and a plurality of buttons 252-258, which are used to define classes (button 252 is used to enable creation of classes) and class relationships. Button 254 is used to define a class inheritance relationship, button 256 is used to define class containment relationships, and button 258 is used to define class association relationships.

In the example shown in FIG. 27 five classes have been defined, and graphical objects representing the five classes are presented in the view area 203. These classes include a SuperClass 230, SubClass 232, SubSubClass 236, BClass 238, and an AClass 244. The inheritance relationship between the SuperClass 230, and the SubClass 232 is indicated by inheritance link 235, and the inheritance relationship between the SubClass 232 and the SubSubClass 236 is indicated by inheritance link 234. Likewise, the containment relationship between the BClass 238 and the SuperClass 230 is indicated by a containment link 240 labeled with containment group name CGroupOfBs. Classes B and A are related by association, and this is indicated by an association link 242 extending from the BClass 238 to the AClass 244. Once the model has been defined, it must be compiled before it can be executed The compilation of these models is one example of a processing task.

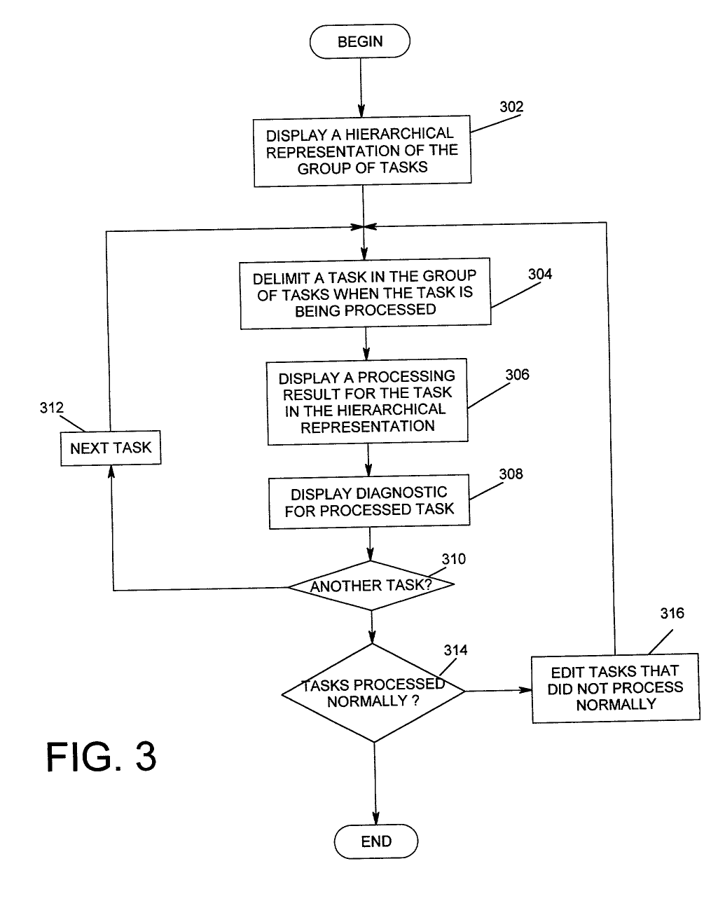

FIG. 3 is a flow chart showing the operations used to practice one embodiment of the present invention. First, an organizational representation (such as a hierarchical representation) of the group of tasks or objects is displayed 302. Then, while one of the tasks in the group of tasks is being processed, the task is delimited, by an indicator such as highlight bar, in the hierarchical representation. This is depicted in block 304. After the processing for the task is completed, a processing result is displayed in the hierarchical representation, as shown in block 306. If a processing diagnostic should be displayed (for example, when the task processing is not completed normally), the diagnostic is displayed 308. The operations of blocks 304-308 are completed for each of the group of tasks. As before, each task is delimited when processing is underway, tagged with an icon or other indicator to display a processing result, and a diagnostic is displayed. If all tasks are processed normally, no further action is required. However, if one or more of the tasks in the group of tasks does not process normally, that task may be called and edited. The process can be repeated thereafter until a normal processing result is achieved for all tasks, as shown in blocks 314 and 316. In one embodiment, the task delimiting and/or display of the processing result is accomplished by examining messages received from the processing task. For example, if the tasks were compiling models with a Java compiler, the compiler messages can be used to control the display of the highlighter and icons.

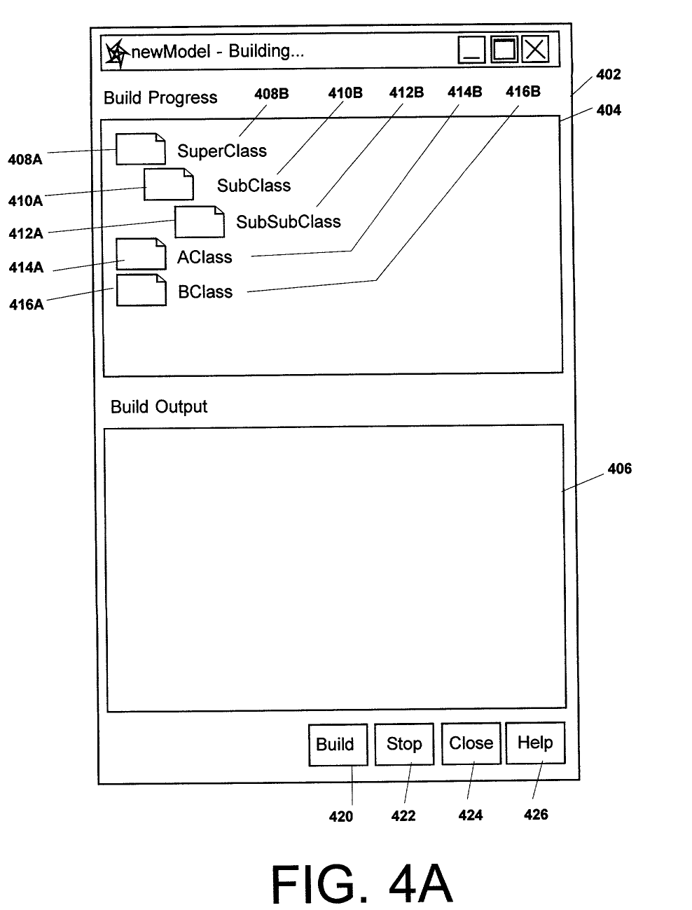

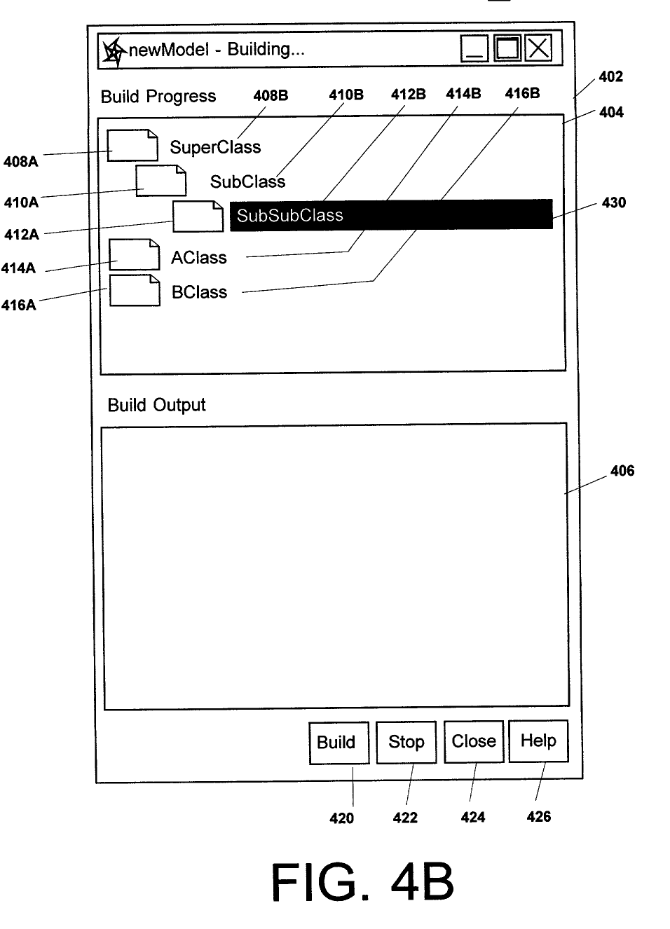

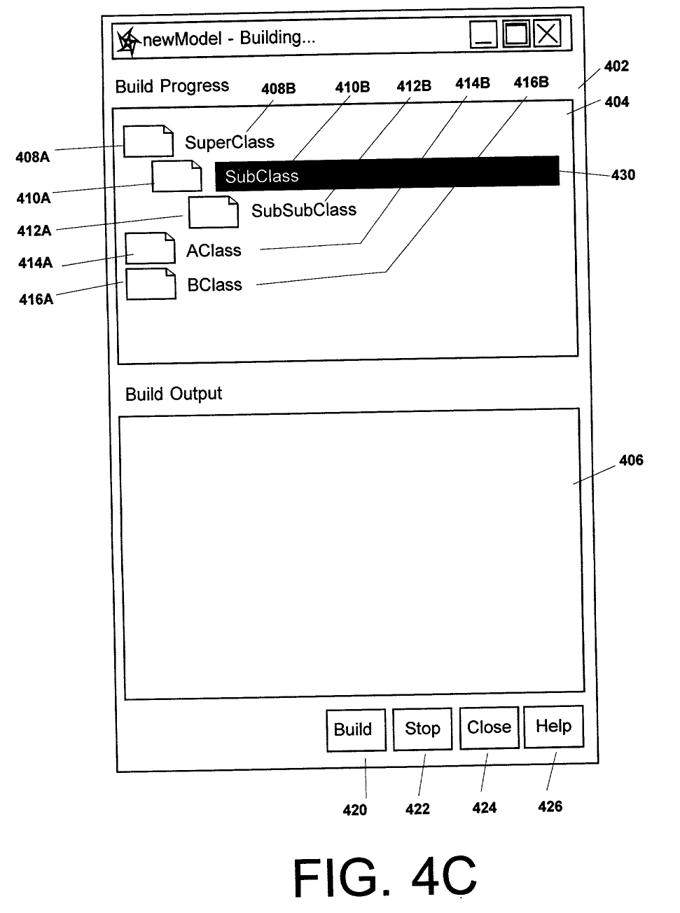

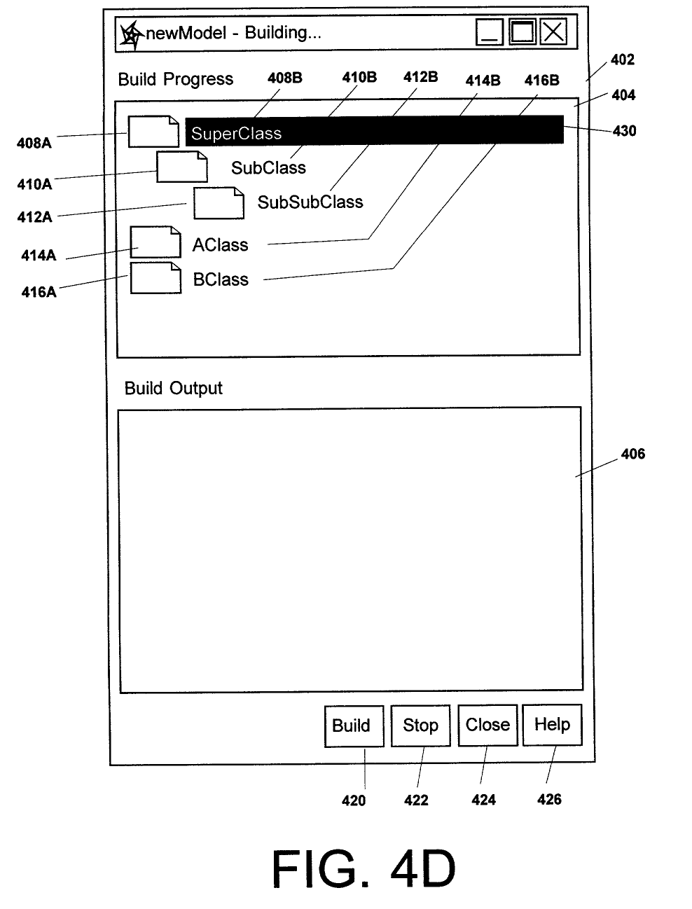

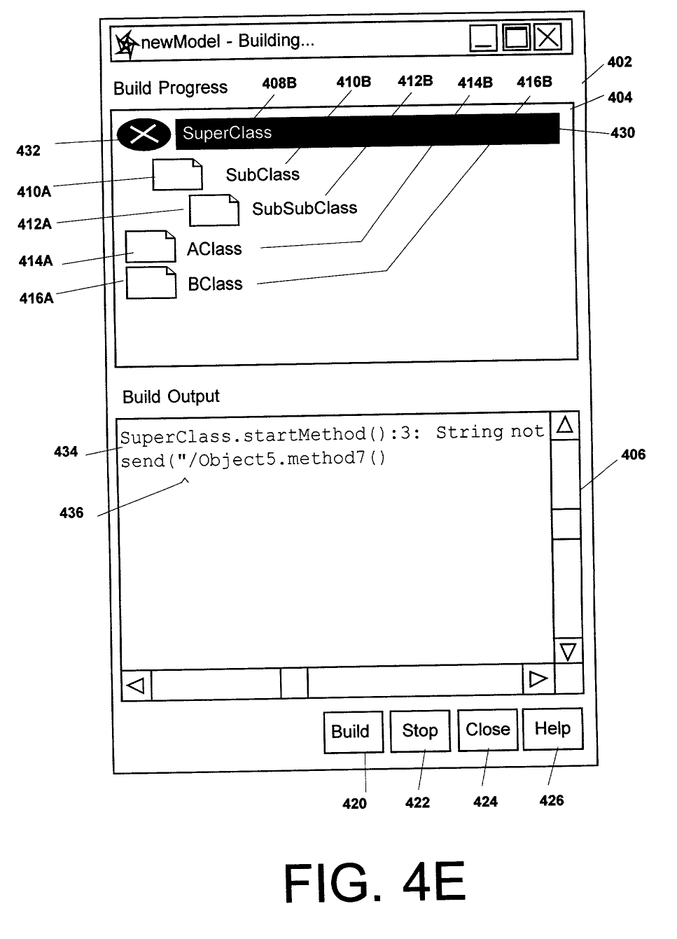

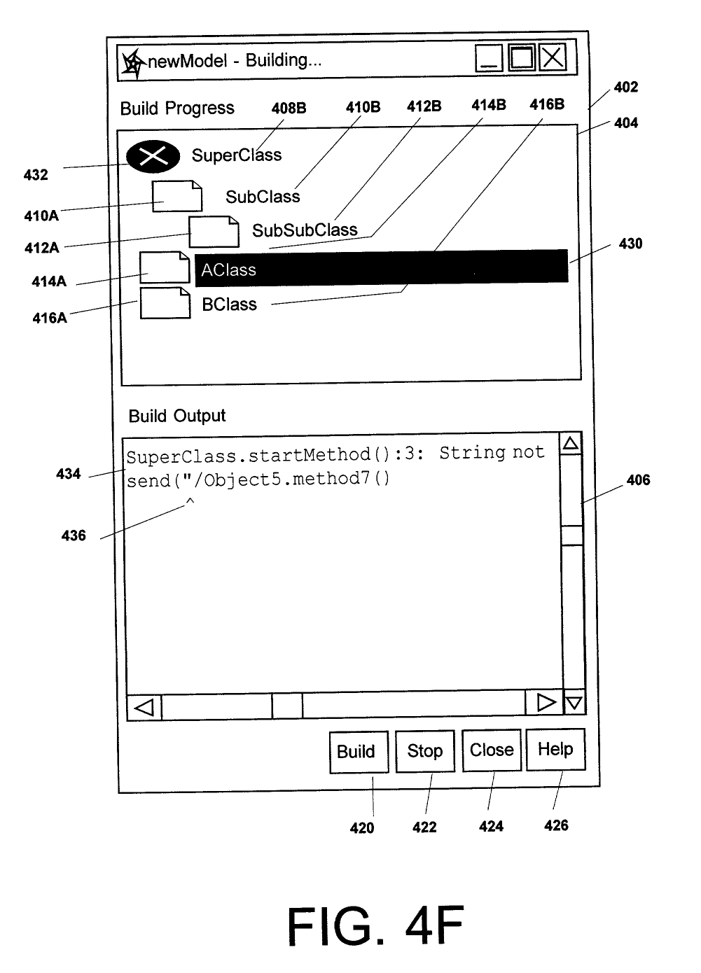

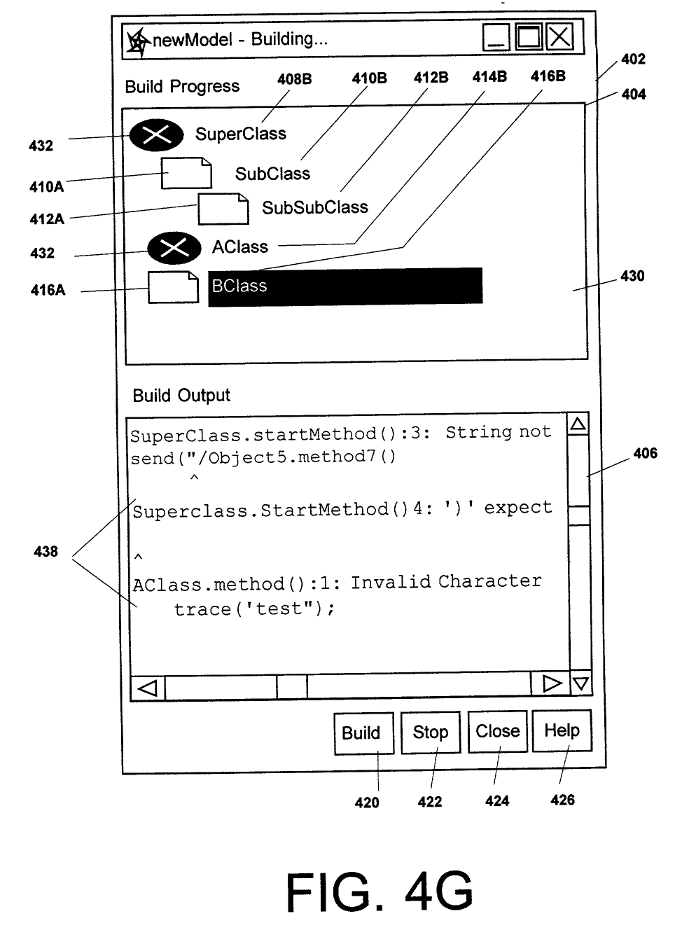

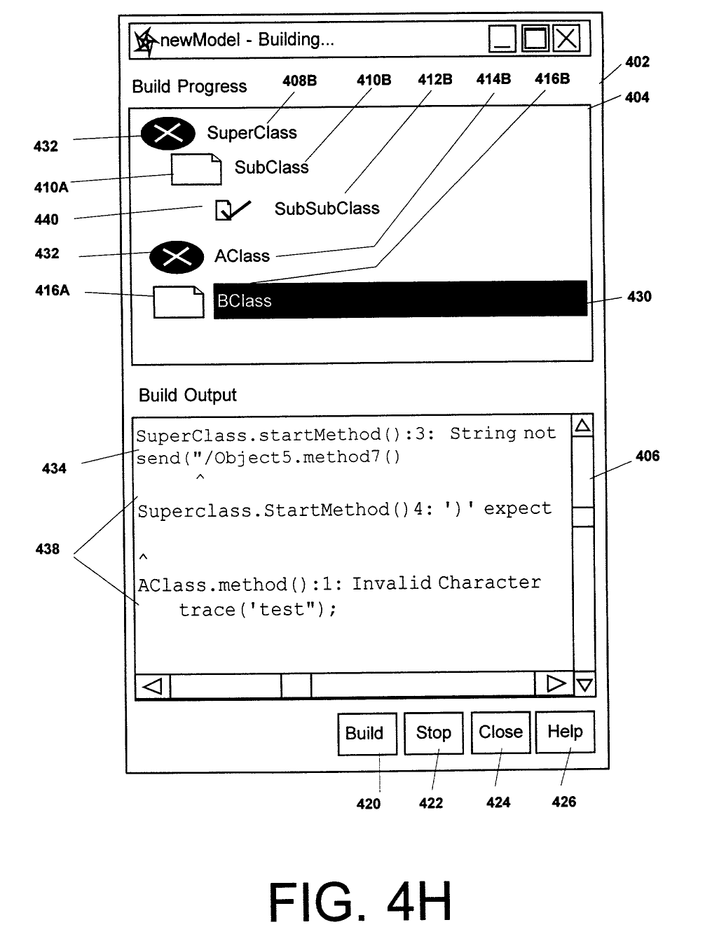

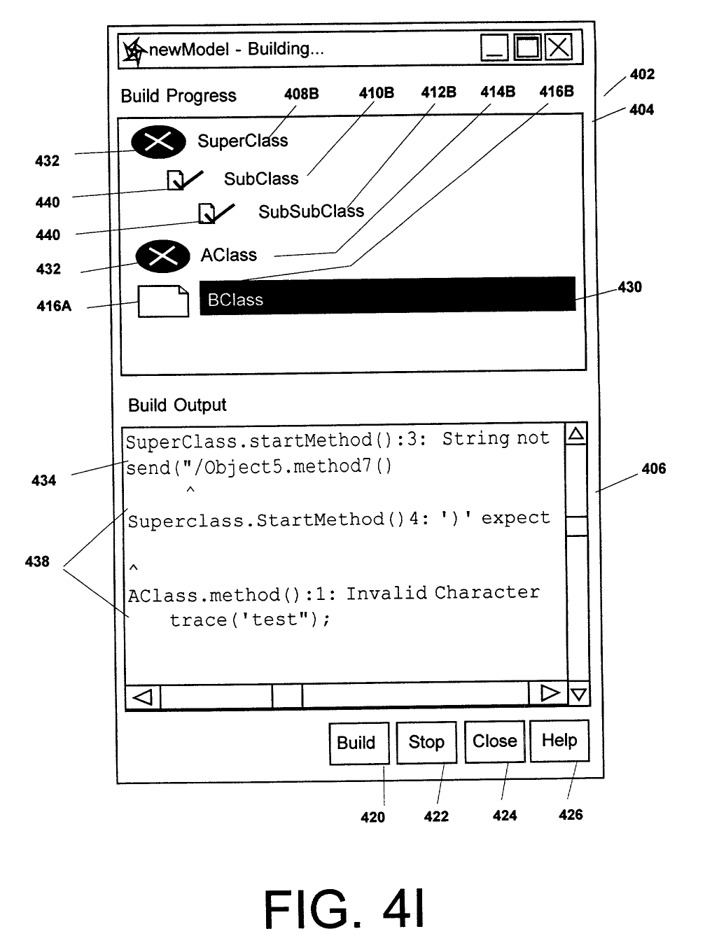

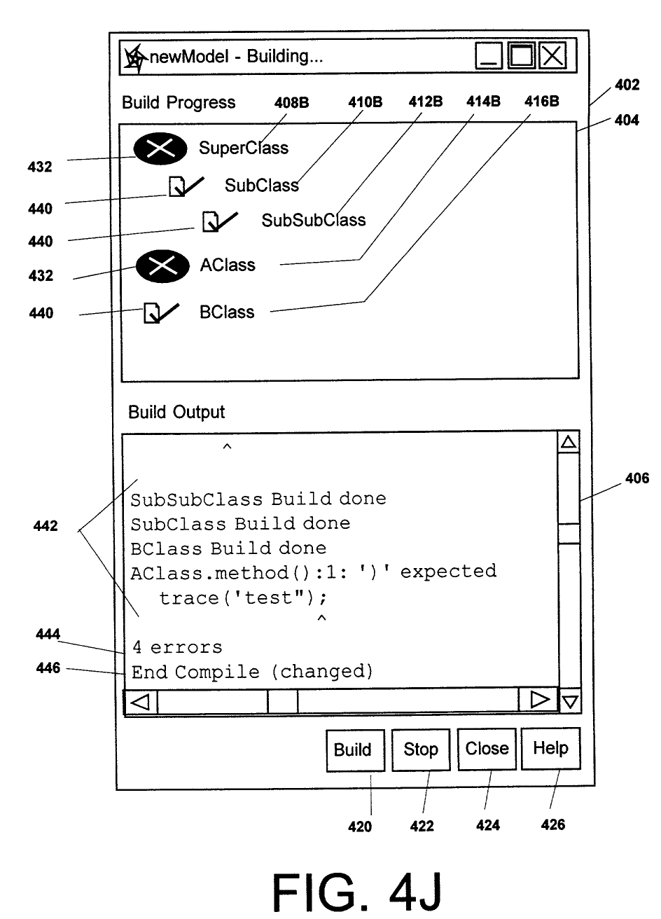

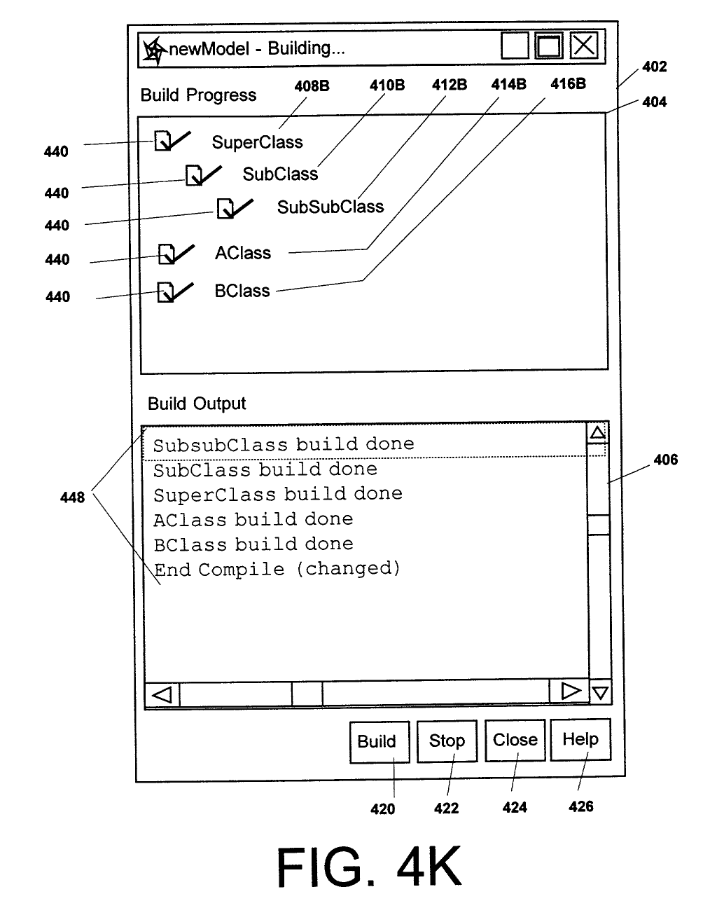

FIGS. 4A-4L are diagrams showing the status of an exemplary embodiment of a multi-phase task-oriented progress indicator, as a number of tasks in a group of tasks are processed. In the illustrative embodiment depicted in FIGS. 4A-4L, each task is the compilation of one class in a group of classes.

FIG. 4A is a diagram showing one embodiment of a hierarchical representation of a group of tasks, including a build dialog window 402 having a first pane 404 and a second pane 406. The build dialog window 402 provides the user with feedback during the compilation process. A hierarchical view of the classes to be compiled (each representing a processing task) is presented in the first window pane 404, while the second window pane displays processing-related messages while the processing is taking place. Vertical and/or horizontal scroll bars or handles may be included in the first 404 and second 406 window panes as required to allow the user to view all of the objects and processing messages.

In the illustrative example, the hierarchical view comprises a SuperClass icon 408A and text 408B, a SubClass icon 410A and text 410B, a SubSubClass icon 412A and text 412B, an AClass icon 414A and text 414B, and a BClass icon 416A and text 416B are presented. These classes are related as described above with respect to FIG. 2. That is, the SubSubClass 236 inherits from the SubClass 232, and the SubClass 232 inherits from the SuperClass 230.

The user can close the build dialog window 402 by selecting the close button 424, or obtain help by selecting the help button 426. The build process can be commenced by selecting the build button 420, or can be started from the model pull down menu. The build process can be terminated by selecting the stop button 422.

FIG. 4B is a diagram showing the build dialog window 402 after selection of the build button 420. The first task to be performed is the parsing of the SubSubClass 236 class. As the computer system 100 parses the SubSubClass class 236, the SubSubClass text 412B is highlighted with shading 430 to indicate that this task is being performed.

After the parsing of the SubSubClass 236 class is completed, the next task is to parse the class that is next in the hierarchy of classes. Accordingly, SubClass 232, which is the parent of the SubSubClass class 236, is parsed.

FIG. 4C is a diagram showing the build dialog window 402 when the SubClass 236 class is being parsed. The shading 430 now highlights the SubClass text 410B.

After the SubClass 232 is parsed, the next task is to parse the next class in the hierarchy, the SuperClass class 230.

FIG. 4D is a diagram showing the build dialog window 402 when the SuperClass has been parsed. Since the task of parsing the SuperClass class 230 is active, the SuperClass text 406B is highlighted by the shading 430.

The outcome of each of the foregoing tasks includes a processing result. Possible processing results include normal completion when the task processing proceeds normally, and a non-normal process completion such as a task abort or the discovery of non-fatal errors. The present invention presents a result icon to the user to indicate the outcome and/or status of the processing task.

FIG. 4E is a diagram showing the build dialog window 402 when the task of parsing the SuperClass class 230 does not proceed normally. When task processing does not proceed normally, a result icon 432 indicating that an error was detected is presented adjacent to the hierarchical representation of the task group, and diagnostic information 434, including a delimiter 436 indicating the position of the error is presented in the second pane 406 of the build dialog window 402. In the illustrated embodiment, the result icon 432 appears adjacent to the task where the error occurred.

FIG. 4F is a diagram showing the build dialog window 402 when the task of parsing the AClass class 244 is being performed. In the illustrated embodiment, an inheritance relationship between the AClass class 244 and the BClass class 238 and the remaining objects was not defined. Hence, the AClass class 244 and BClass class 238 are simply parsed in the order that they were created.

FIG. 4G is a diagram showing the build dialog window 402 when the task of parsing the BClass class 238 is being performed. The build dialog window 402 also displays a result icon 414A, indicating that the parsing of the AClass class has revealed an error. The result icon is displayed adjacent to the AClass text 414B, and a diagnostic message is displayed in the second pane 406 of the build dialog window 402.

FIG. 4H is a diagram showing another example of the build dialog window 402 during the build process. At this time, the SubSubClass class 236 was successfully written, and a result icon indicating normal processing 440 is displayed adjacent the SubSubClass text 412B.

FIG. 4I is a diagram showing another example of the build dialog window 402 during the build process. At this time, the SubClass class 232 was successfully written, and a result icon indicating normal processing 440 is displayed adjacent the SubClass text 410B.

FIG. 4J is a diagram showing another example of the build dialog window 402 during the build process. At this time, the build process is completed, including the building of the SubSubClass class 236, the SubClass class 232, and the SuperClass class 230. Additional summary diagnostic information, including information relative to each task 442, a summary of all tasks 444, and an end statement 446 is presented in the second pane 406 of the build dialog window 402. At any time during the foregoing build process, the user can select the stop button 422 to interrupt the build process.

After the build process has completed, the user can make appropriate corrections in the classes and their relationship between one another as required to correct the errors that arose. After completion, the build process can be commenced again by selecting the build button 420.

FIG. 4K is a diagram showing another example of the build dialog window 402 after the build process has completed. In this illustrated embodiment, the build process completed normally (with no errors), and an appropriate result icon 444 is displayed adjacent to each of the classes. Further a diagnostic message 448 indicating that each of the classes were compiled and built without error is displayed in the second pane of the build dialog window 402. The user can then close the build dialog window 402 by selecting the close button 424.

In the above-described embodiment, the hierarchical representation of the processing tasks was displayed by presenting a horizontal list of the classes in their hierarchical order. In addition, each hierarchical level is indicated by indenting the associated icon. In an alternative embodiment, the hierarchical representation of the processing tasks is displayed merely by the movement of the highlight bar 430. Since the highlight bar 430 follows the process as it proceeds from the lowest to the highest class in the hierarchy (from SubSubClass to SuperClass in the above example), a hierarchical representation of the tasks is presented by the motion of the highlight bar 430 during the process.

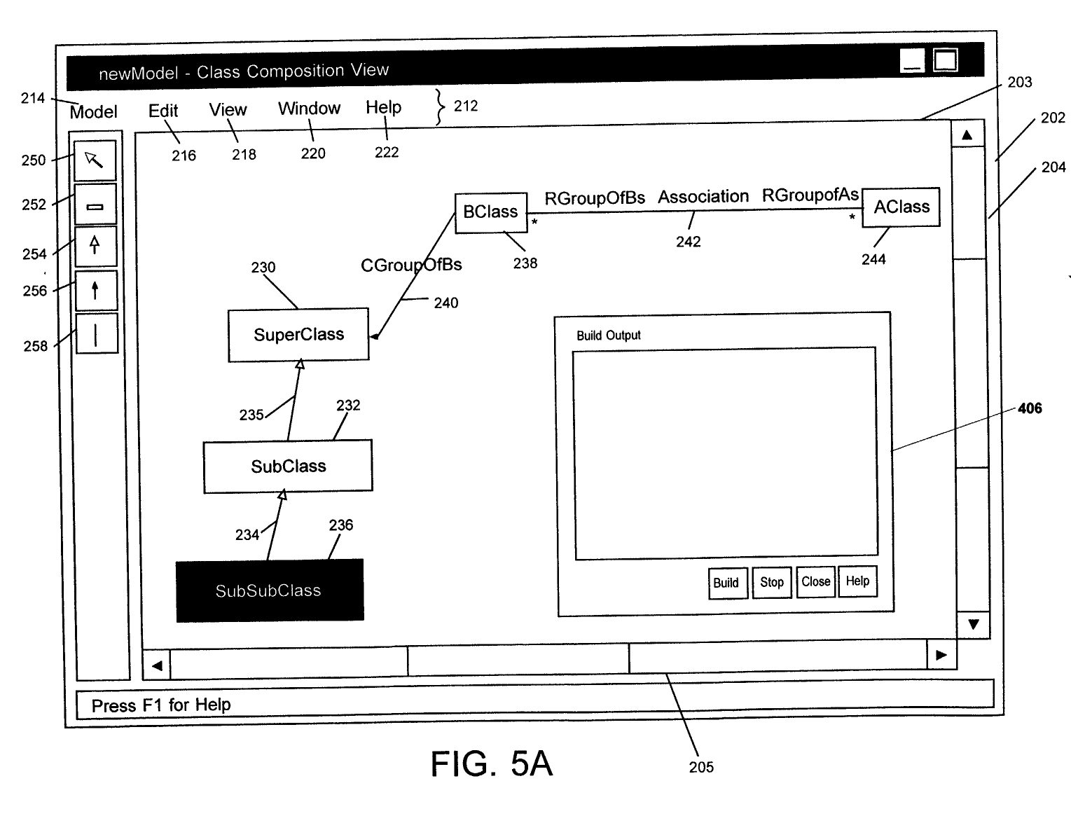

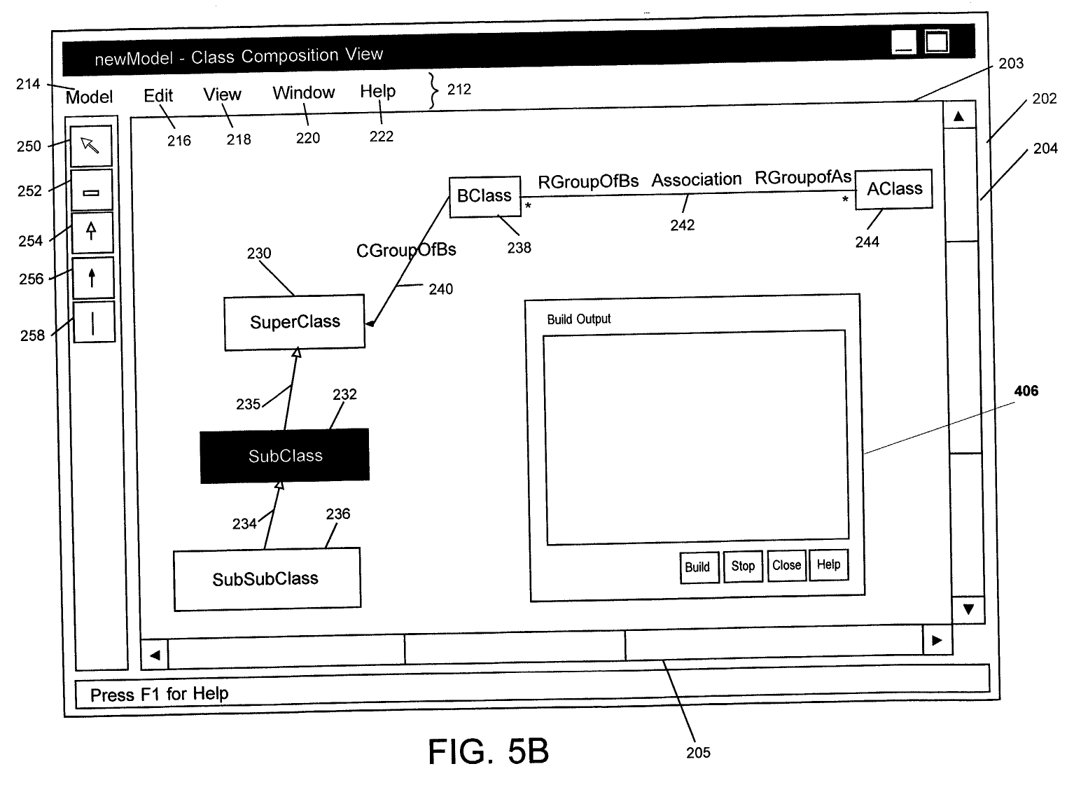

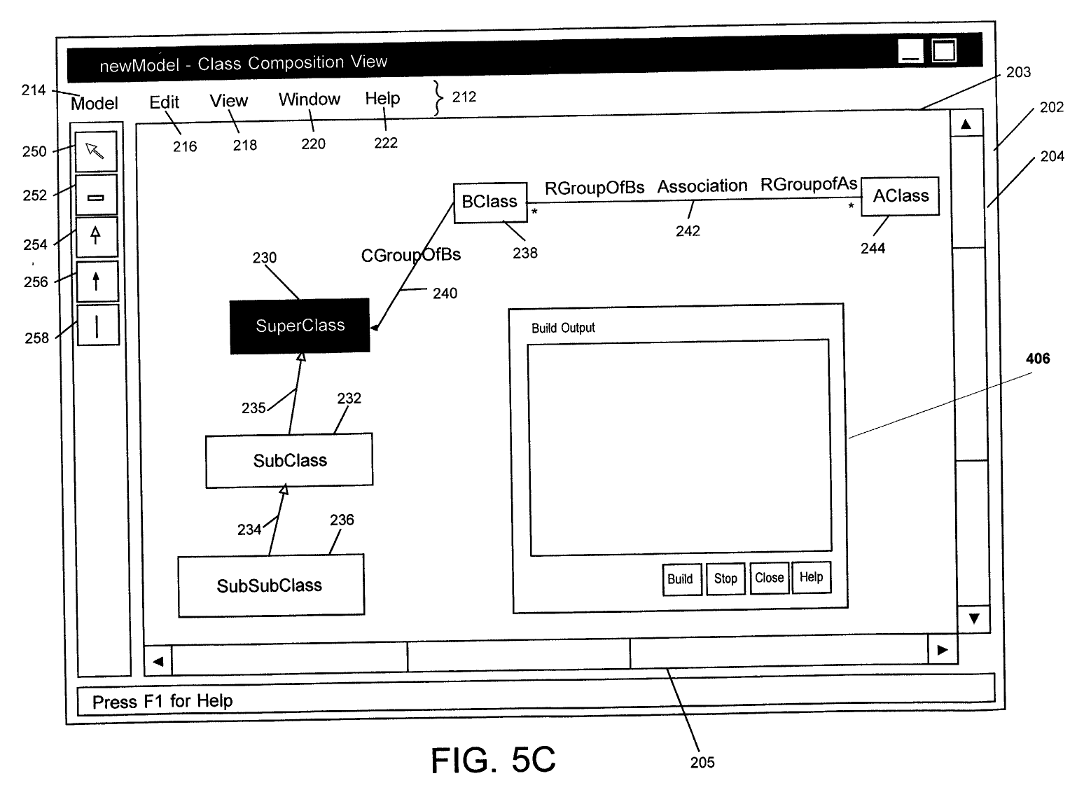

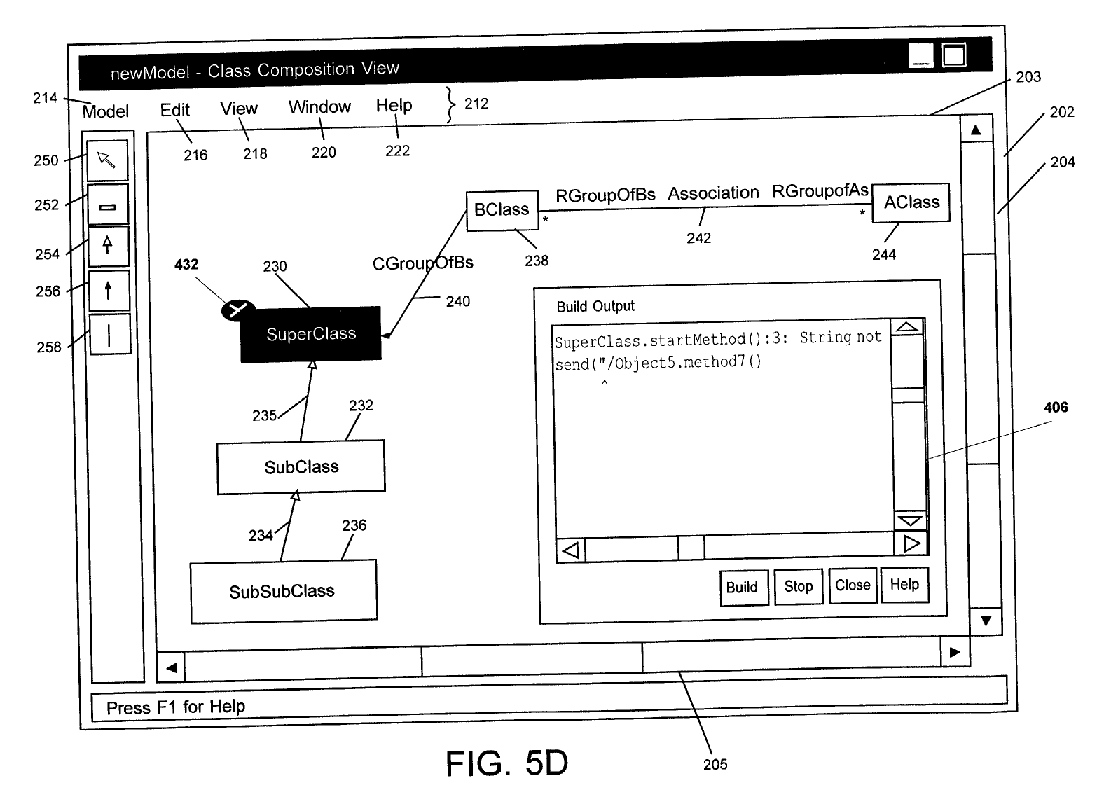

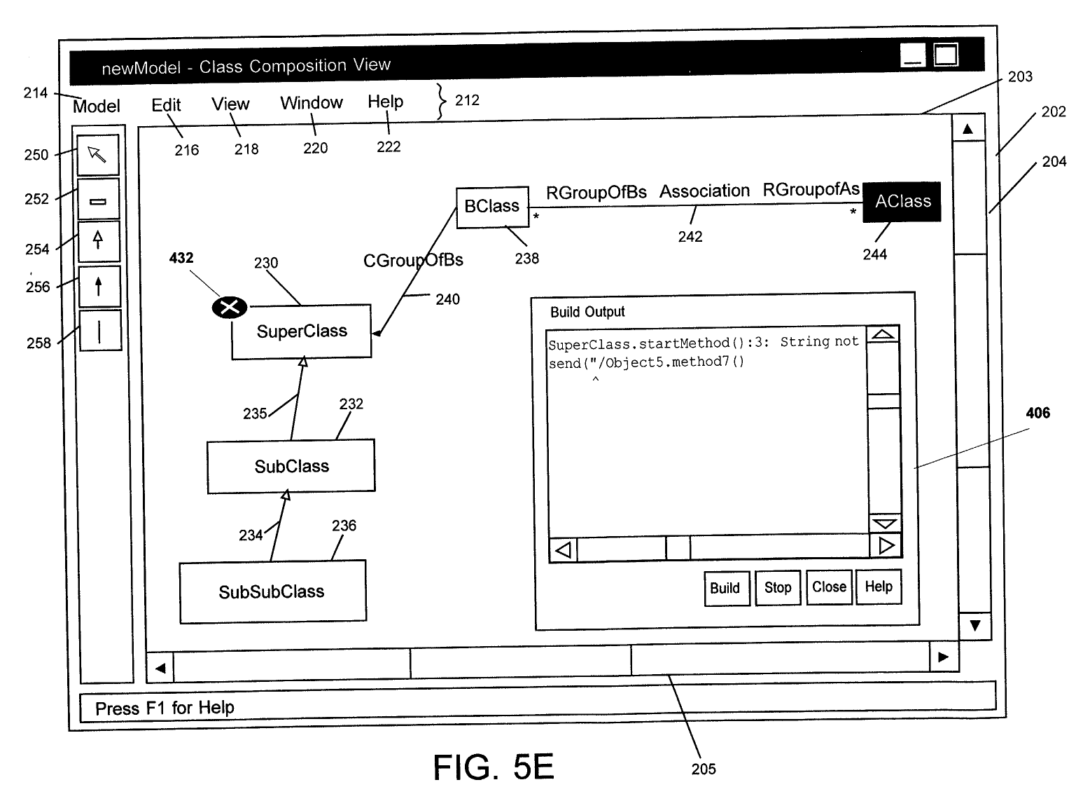

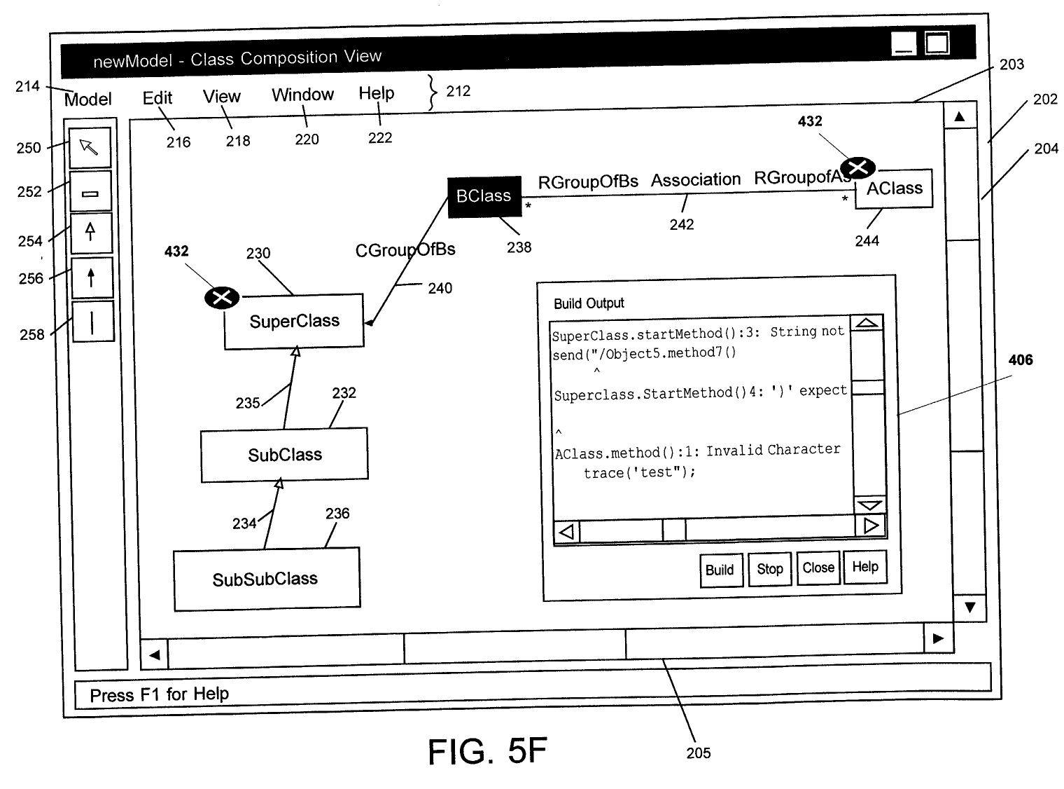

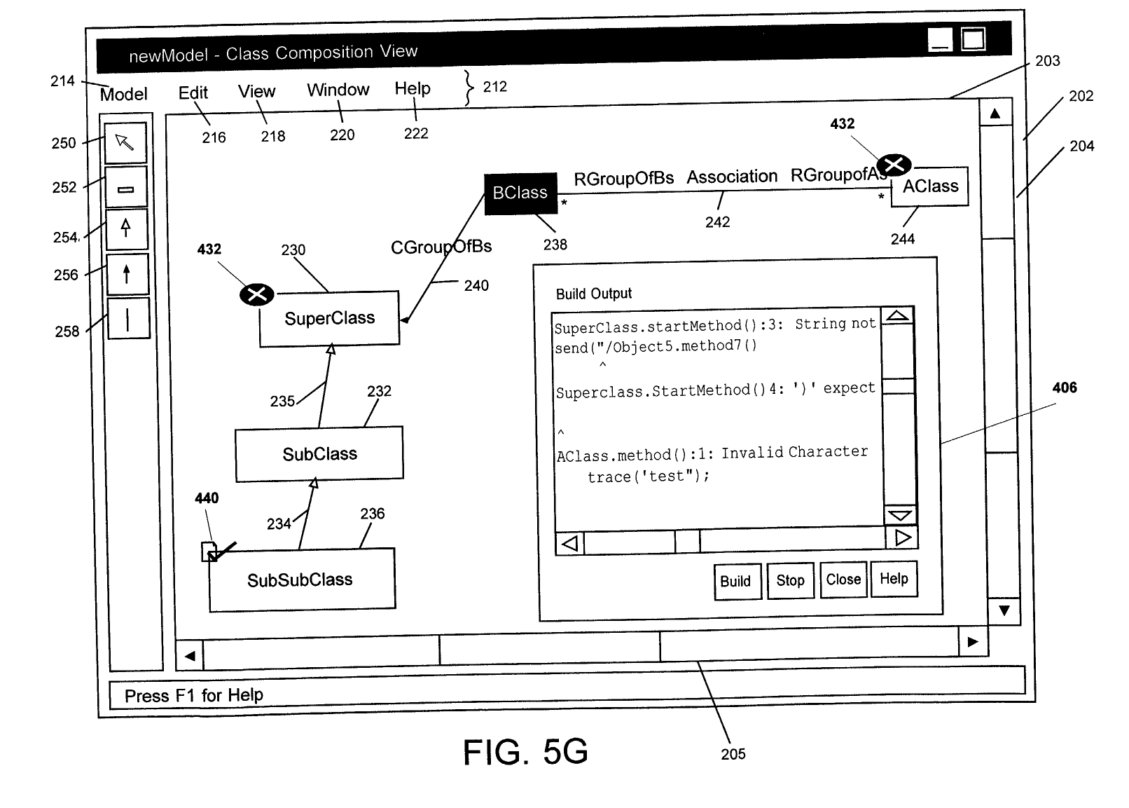

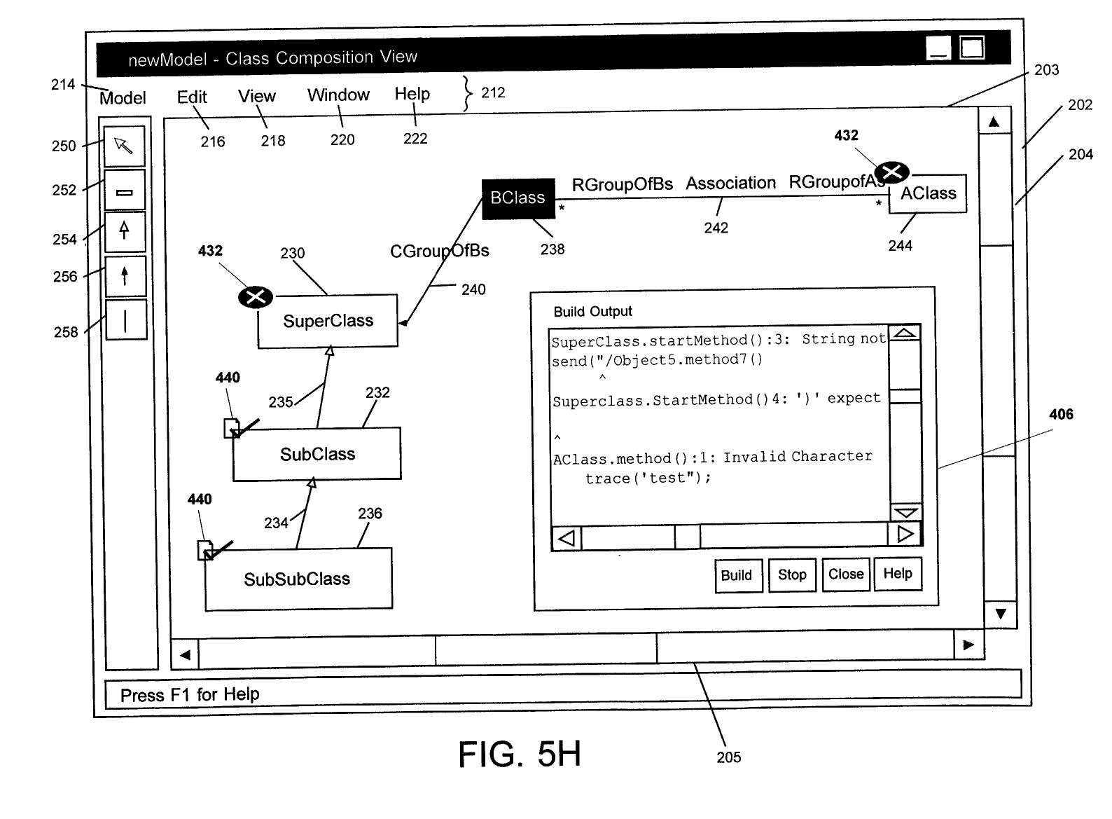

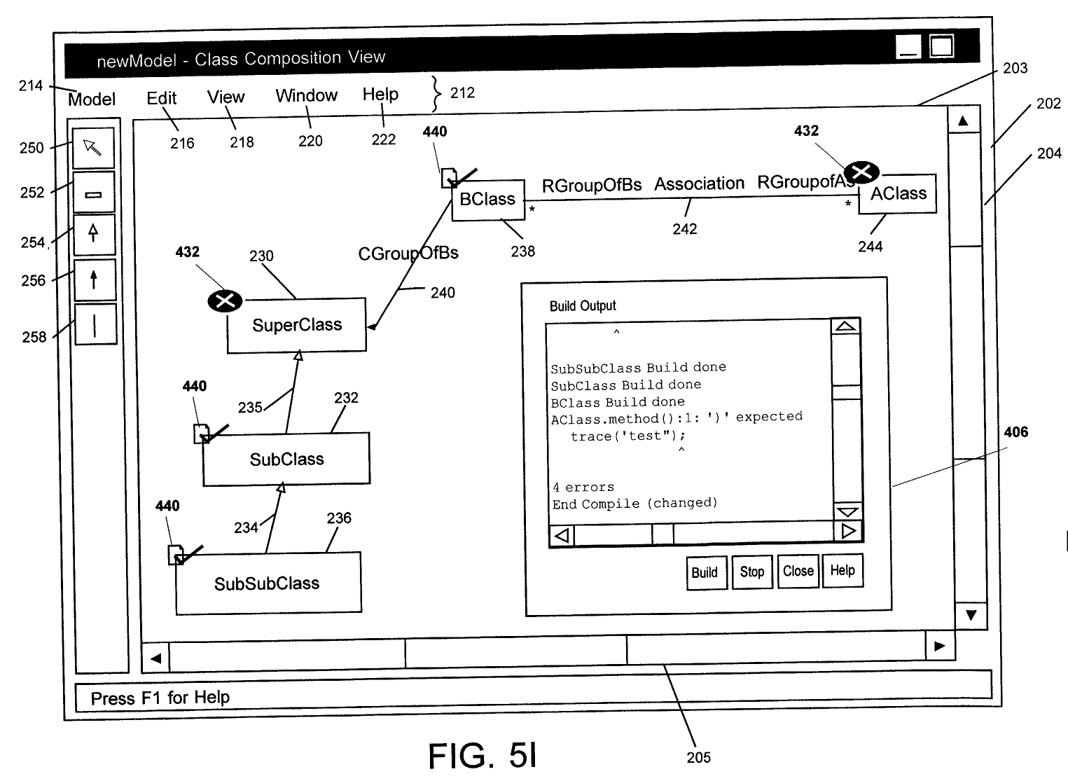

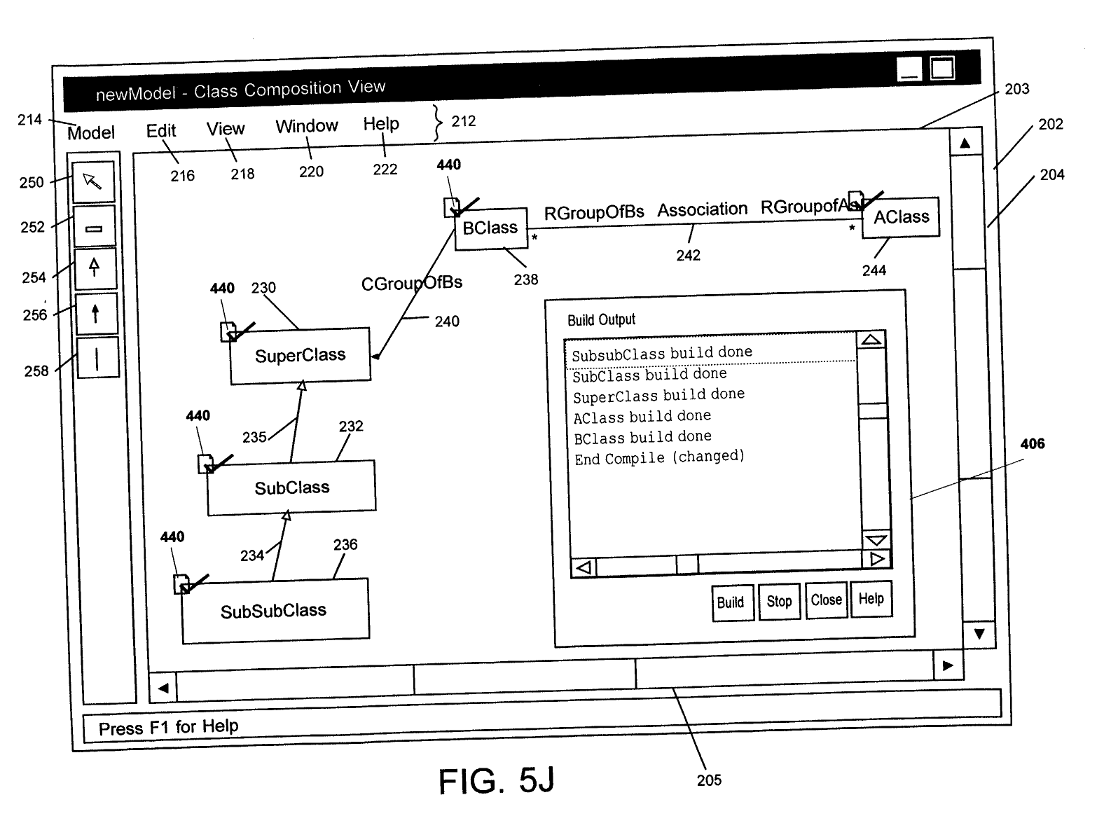

FIGS. 5A-5J is a diagram showing another embodiment of the present invention. In this embodiment, the classes are presented in the ObjChart window 202, and the processing of the tasks (here, the building of the tasks shown in the ObjChart window 202) is indicated by highlighting each task to indicate processing of the task has begun or has been completed. Result icons 432 and 440 may be presented adjacent to the icons representing the tasks to indicate the processing result for each task. If desired different highlighting or result icons can be used to denote when processing of the task has begun, when it is underway, and when it is completed. In this embodiment, the user can control (initiate, stop, pause, and cancel) the build process by selecting items in the menu bar 212. A diagnostic window 406 may be optionally presented in the ObjChart window 202, to display diagnostics to the user. Further, the user interface to control the build process can be placed in the diagnostic window 406, as shown.

Conclusion

This concludes the description of the preferred embodiments of the present invention. In summary, the present invention describes a method, apparatus, and article of manufacture for displaying the progress of a hierarchically structurable group of tasks.

The method comprises the steps of displaying a hierarchical representation of the group of tasks, delimiting a task in the group of tasks when the task is being processed, and displaying a processing result for the task in the hierarchical representation. In one embodiment, task result icons are displayed adjacent to the task to indicate the result of the task processing and a diagnostic window is included to provide the user with detailed information regarding the processing of each task. The article of manufacture comprises a medium tangibly embodying process steps for practicing the foregoing method.

The apparatus comprises a means for displaying a hierarchical representation of the group of tasks, means for displaying a highlight bar or similar visual indication to delimit a task in the group of tasks while the task is being processed and a result icon or similar visual indication to display a processing result for the task.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. For example, while the above disclosure describes the application of the present invention to build process tasks in an object-oriented programming environment, the present invention may also be practiced using any processing task. Further, while the foregoing provides a specific example wherein the group of tasks is structurable into a hierarchical organizational structure, the present invention is not so limited. Using the teaching provided above, the present invention can also be used with tasks grouped in other organizational structures as well. For example, all of the subtasks in the group may be interdependent, but none hierarchically superior to any of the others. The organizational structure of such a group of tasks can be displayed, and the progress of performing such tasks provided using the techniques described herein.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of displaying progress of a hierarchically structurable group of tasks, comprising the steps of:
(a) displaying a hierarchical representation of the group of tasks;
(b) delimiting a task in the group of tasks when the task has been processed; and
(c) displaying a processing result for the task in the hierarchical representation.

2. The method of claim 1, further comprising the step of repeating steps (b) and (c) for each task in the group of tasks as each task is processed.

3. The method of claim 2, wherein the step of displaying a processing result for the task comprises the step of presenting a result icon adjacent to the hierarchical representation of the task, wherein the result icon is selected from a group comprising a first icon indicating that the task has processed normally and a second icon indicating that the task has not processed normally.

4. The method of claim 1, further comprising the step of displaying diagnostic information about each processed task.

5. The method of claim 4, wherein the diagnostic information is displayed adjacent to the hierarchical representation of the group of tasks.

6. The method of claim S wherein the diagnostic information comprises an error statement when the task is not processed normally.

7. The method of claim 1, wherein each task comprises a compiling of an object class, the object class being a member of a model class hierarchy.

8. An apparatus for displaying progress of a hierarchically structurable group of tasks comprising:
means for displaying a hierarchical representation of the group of tasks;
means for delimiting a task in the group of tasks when the task has been processed; and
displaying a processing result for the task in the hierarchical representation.

9. The apparatus of claim 8, further comprising means for repeatedly delimiting the task in the group and displaying a processing result for the task in the hierarchical representation for each task in the group of tasks as each task is processed.

10. The apparatus of claim 9, wherein the means for displaying a processing result for the task comprises means for presenting a result icon adjacent to the hierarchical representation of the task, wherein the result icon is selected from a group comprising a first icon indicating that the task has processed normally and a second icon indicating that the task has not processed normally.

11. The apparatus of claim 8, Her comprising means for displaying diagnostic information about each processed task.

12. The apparatus of claim 11, wherein the diagnostic information is displayed adjacent to the hierarchical representation of the group of tasks.

13. The apparatus of claim 12, wherein the diagnostic information comprises an error statement when the task is not processed normally.

14. The apparatus of claim 8, wherein each task comprises a compiling of an object class, the object class being a member of a model class hierarchy.

15. A program storage device, readable by a computer, tangibly embodying at least one program of instructions executable by the computer to perform method steps of displaying progress of a hierarchically structurable group of tasks, the method comprising the steps of
(a) displaying a hierarchical representation of the group of tasks;
(b) delimiting a task in the group of tasks when the task has been processed; and
(c) displaying a processing result for the task in the hierarchical representation.

16. The program storage device of claim 15, wherein the method steps further comprise the step of repeating method steps (b) and (c) for each task in the group of tasks as each task is processed.

17. The program storage device of claim 16, wherein the method step of displaying a processing result for the task comprises the method step of presenting a result icon adjacent to the hierarchical representation of the task, wherein the result icon is selected from a group comprising a first icon indicating that the task has processed normally and a second icon indicating that the task has not processed normally.

18. The program storage device of claim 15, wherein the method further comprises the step of displaying diagnostic information about each processed task.

19. The program storage device of claim 18, wherein the diagnostic information is displayed adjacent to the hierarchical representation of the group of tasks.

20. The program storage device of claim 19, wherein the diagnostic information comprises an error statement when the task is not processed normally.

21. The program storage device of claim 15, wherein each task comprises a compiling of an object class, the object class being a member of a model class hierarchy.

22. A method of displaying a progress of a structurable group of tasks, comprising the steps of:
(a) displaying an organizational representation of the group of tasks;
(b) delimiting a task in the group of tasks when the task has been processed; and
(c) displaying a processing result for the task in the hierarchical representation.
